(19) United States
(12) Patent Application Publication
(10) Pub. No.: US 2013/0015344 A1
(43) Pub. Date: Jan. 17, 2013

(54) BACKGROUND NOISE CORRECTION IN QUADRUPOLE MASS SPECTROMETERS

(71) Applicant: Felician MUNTEAN, Danville, CA (US)

(72) Inventor: Felician MUNTEAN, Danville, CA (US)

(73) Assignee: BRUKER DALTONICS, INC., Billerica, MA (US)

(21) Appl. No.: 13/285,168

(22) Filed: Oct. 31, 2011

Related U.S. Application Data
(60) Provisional application No. 61/508,219, filed on Jul. 15, 2011.

(51) Int. Cl. H01J 49/26

(52) U.S. Cl. 250/282

(57) ABSTRACT

In a quadrupole mass spectrometer, which measures ion currents of a single mass with substantially constant RF and DC voltages during a measuring period and measures ions of different masses by varying the RF and DC voltages, a statistical evaluation is performed during data acquisition by a determination of the distribution of the measured and digitized noise values around an average noise level in the mass spectrometer output signal. The determined noise levels are subtracted from the signal output values separately for each measurement period.

### BACKGROUND

The invention relates to the consideration of background noise in single or multiple quadrupole mass spectrometers to achieve highest accuracy for quantitative analyses. Single quadrupole (“single quads”) or triple quadrupole mass spectrometers (“triple quads”) are usually used as sophisticated detectors for gas chromatographs (GC) to identify the substances eluting from the GC column, separated in time from each other. The specialist in the art knows these types of mass spectrometers, so no detailed description of construction or operation will be presented here. Usually, electron bombardment (El) or chemical ionization (CI) ion sources are applied to ionize the substances in these instrument combinations. In triple quadrupole instruments, ions selected by the first quadrupole are fragmented by collisions in the second quadrupole section, and the fragment ions are measured as fragment ion spectra in the third quadrupole.

Whenever the term “mass of the ions” or simply “mass” is used here in connection with ions, it is always the “mass-to-charge ratio” m/z which is meant, i.e. the physical mass m of the ions divided by the dimensionless and absolute number z of the unbalanced positive or negative elementary charges which this ion carries. In electron bombardment (El) and chemical ionization (CI) ion sources, the number z of excessive elementary charges of the ions usually is z=1, so it becomes unnecessary to speak of “mass-to-charge-ratios”, the term “mass” can be used.

The measurement of the ion currents during the spectrum acquisition is performed by ion detectors comprising secondary electron multipliers (SEM), electronic amplifiers for amplifying the electron current from the SEM, and analog-to-digital converters (ADC). There are several types of secondary electron multiplier (often called “multiplier” for short). In the oldest type, which is still in use, the secondary-electron multiplier consists of discrete dynodes, between which voltages in the order of 100 to 200 volts per pair of dynodes are applied by a voltage divider. Secondary electron multipliers exist with between 8 and 18 dynodes. The ions impinge on the first dynode, thus generating secondary electrons, which are accelerated and then impinge onto the second dynode. Each of these electrons then generates, on average, several secondary electrons so that an avalanche of electrons forms along the dynodes. The amplification is the number of electrons from the last dynode per ion impinging onto the first dynode. The amplification of commercially available multipliers can be adjusted over a wide range, in the extreme case between 10⁴ and 10⁸, by changing the total voltage across the dynodes, although operating the multiplier at the highest voltages generally leads to very rapid aging.

Other types of secondary-electron multipliers are the so-called “channeltron multipliers” and the “multichannel plates”. The channeltron multiplier consists of a single channel with an opening in form of a trumpet, the channel bent to a kind of spiral. The multichannel plate is usually supplied in a design consisting of two plates, each consisting of millions of parallel channels, one behind the other with channel directions at a slight angle to each other (chevron arrangement). In both these types of secondary-electron multiplier, voltage drops exist across the internal surface of the channels which, given an appropriate shape and surface conditioning, lead to electron avalanches in the channels. The amplification ranges are similar to those of dynode secondary-electron multipliers.

The avalanche of electrons from the multiplier is directed to a measuring electrode, and the electron current is amplified and digitized. The avalanche usually has an average duration at half maximum of a few nanoseconds. In principle, therefore, it is possible to simply count single ions arriving at the detector as long as the ions follow each other with a few nanoseconds time difference. This is the case with ion currents up to about 10⁸ ions per second, or about 16 picoampere, but requires extremely fast ion detector systems, with narrow amplifier bandwidth and fast ADC. With higher ion currents, the number of events with arrival of multiple ions at about the same time increases, and overlapping avalanches from multiple ions occur.

To achieve highest sensitivity, the amplifier's amplification and bandwidth, and the measuring rate and bit width of the ADC have to be chosen or adjusted correctly for a given multiplier, to measure all ions with lowest possible losses well above background noise. The background considered here refers mainly to the inherent electronic noise of the detection system, mainly thermal noise, commonly called “electronic baseline” which has significantly distinct statistical characteristics when compared to the ion pulse signals. Once all these parameters are chosen correctly, the optimum amplification of the multiplier can be adjusted by automated methods, as described in US 2009/0206247 A1 (A. Holle, 2008), for instance.

For best quantitative work, the background noise has to be correctly subtracted. This is usually done prior to the actual sample analysis by the measurement of empty mass spectra, without supplying any substances to the ion source, and with the detector high voltage off, such that the data points in the spectrum represent purely the contribution of the electronic baseline noise and determine the background noise level along the mass spectrum. In this case, the average background noise is determined simply as the average of all the points in the spectrum. This background noise level is then subtracted from the analytical mass spectra. This method, however, may not be accurate enough to account for background noise drifts as a result of electronic circuit drifts with temperature, spurious electronic noise interference, even a mass-dependent noise induced by the RF generator, or by other effects.

With quadrupole mass spectrometers, the spectrum quite often is not acquired by a continuous scan over all masses of the mass scale, but by jumping from one integer mass to another integer mass, generally called single ion monitoring (SIM) or multiple reaction monitoring (MRM) when the system runs in MSMS mode. These types of operation offer a higher sensitivity because there is more measuring time, concentrated only on ions of interest rather than on all ions in a larger mass range. The jumps are generated by stepwise changing the RF and DC voltages supplied to the quadrupole rods. For each ion mass of interest, a measuring time (dwell time) between 0.5 to 1000 milliseconds can be chosen, significantly longer than the time allowed for scanning each mass if they were part of a full scan of a mass range, such that the SIM mode sensitivity can be very high.

In these high sensitivity modes, when the mass spectrometer analyses a sample at the limit of detection, the ion signal consists mainly of single ion pulses and the analysis resumes by fixing the RF and DC voltages to select only one mass and measuring these single ion pulses for a period of time (dwell time). In the analog mode of operation, the electronic background noise needs to be subtracted before integrating the ion pulse signals. The ion pulses can have a wide pulse height distribution and it becomes extremely important to subtract the exact background value, without cutting off the smallest ion pulses. Because the electronic noise background can vary slightly in time due to temperature drifts and spurious voltage noise interferences, it is desirable to measure the electronic noise dynamically, when the instrument is on, in presence of single ion pulses, prior to or during data collection. However, during data acquisition, the real ion signal in form of isolated ion pulses is superimposed to the electronic noise baseline so a simple averaging cannot be used to determine and subtract the background.

### SUMMARY

In accordance with the principles of the invention, a method for the determination and subtraction of electronic noise levels dynamically, during data acquisition, when the data points consist of sparse single ion pulses superimposed on a dominant electronic noise signal uses statistical investigations of all measurements for a single ion mass. The invention is used with quadrupole mass spectrometers, which measure the current of ions of a single mass while keeping rather constant the RF and DC voltage during the measuring period (“dwell time”). Ions of different masses are measured by stepwise variations of the RF and DC voltage, in some measuring modes the measurements do not necessarily occur in mass value sequence.

The statistical evaluation is performed by a determination of the distribution of the measured and digitized noise values around an average noise level. By the laws of statistics, the digitized noise values should form a Gaussian distribution. Graphically, the distribution may be shown as a so-called histogram, containing the numbers of all measurement values appearing in preselected value ranges, ordered according to increasing values. The mass spectrometric evaluation forms tables, counting noise values inside the value ranges, and determining the maximum and the width of the Gaussian distribution by well-known mathematical methods, e.g., by a least square fitting of the Gaussian curve to the histogram, or by calculating centroid (center of gravity) and width by statistical methods.

The position of the maximum of the Gaussian distribution forms the average noise level iₐ of the ion current i, the width σ of the Gaussian distribution represents the scattering width of the noise. Ion current values above a detection threshold iₗᵢₘ=iₐ+b×σ have a certain probability to be true ion current peaks, not just noise peaks. The probability of a peak to be a true ion peak can be calculated from the known characteristics of the Gaussian distribution. The constant b can be chosen so that all superseding peaks have a given minimum probability to be a true ion peak, say 99.9 percent, for instance.

The true integrated ion current i₁=Σiₙ measured in the time interval Δt is given by the sum of all measurement values iₘ greater than iₗᵢₘ, each measurement value iₘ corrected by subtraction of the average noise level iₐ: iₙ=iₘ−iₐ. The average ion current in the time interval is the integrated ion current iᵢ divided by the time interval Δt.

Any ion current can be measured either by counting the ions per unit of time, or by measuring the average ion current, the latter usually by integrating the amplified ion current and dividing by the integration time, as described above. If the ion current is low enough and the amplification of the multiplier is chosen so high that the current of each electron avalanche clearly supersedes the detection threshold iₗᵢₘ, the number of ions can be counted instead of determining the average ion current, just counting the peaks above the threshold iₗᵢₘ. If the number of ions measured within the time period is much smaller than the number of measurements, the number of peaks superseding the detection threshold iₗᵢₘ represents well the number of ions.

For larger numbers of ions approaching the number of measurements, corrections can be used to consider the rate of overlapping peaks. If the number of ions is on the order of the number of measurements or is even larger, it may no longer be possible to count the ions; then, the integration mode describe above becomes the method of choice. In one preferred mode of operation the detector gain is kept high enough to clearly observe single ion pulses but still low enough to avoid saturation of larger signals. In this mode, the ion pulses have different heights, a distribution of heights. In order to clearly integrate (or count) the smallest ion pulses near the background level, it becomes important to measure the electronic background level in a dynamic fashion, during analysis.

If the average has to be measured for high ion currents, the noise during the time period for the measurement of this mass cannot longer be seen and investigated. Nevertheless, in this case, the precision of determination of the background noise is not critical anymore and it is not necessary to perform a dynamic measurement of the background noise. The maximum and width of the Gaussian distribution then has to be taken from another measuring period; either from a measurement of another nearby mass during a mass scan, or from another nearby time period of the GC run for a measurement of the same mass.

The relation between the average ion current measured in this way and the ion current measured by ion counting is given by the mass dependence of the multiplier's sensitivity. In the mass range in question, the sensitivity of the multiplier is roughly inversely proportional to the square root of the mass, but additionally depends on the structure of the ions. The relationship changes with multiplier age and use. If both measurements methods, ion counting and average ion current measurement, are continuously applied in parallel wherever possible, the mass dependence of the multiplier sensitivity can be determined and followed. The knowledge of this dependence, on the other hand, can be used to transform values between number of ions (true ion current) and the average ion current measured by the multiplier. By following this dependence over long times, the dependence even can be used to occasionally correct the voltage of the multiplier for an optimum performance.

### BRIEF DESCRIPTION OF THE DRAWINGS

FIG. 1 is a graph with ion current on the vertical axis and time on the horizontal axis that presents a short measurement period with digitized noise values and five single ion pulse peaks (1-5). The average noise level (6) and the detection threshold (7) are marked by dashed lines.

FIG. 2 is a histogram with number on the vertical axis and ion counts on the horizontal axis that shows digitized noise values with the Gaussian curve (dashed curve) fitted into the histogram values. The average noise level (6) and detection threshold (7) are marked by dashed lines. The width σ of the Gaussian curve is indicated by arrow (8).

FIG. 3 is a flowchart showing the steps in an illustrative method for background noise correction in accordance with the principles of the invention.

### DETAILED DESCRIPTION

While the invention has been shown and described with reference to a number of embodiments thereof, it will be recognized by those skilled in the art that various changes in form and detail may be made herein without departing from the spirit and scope of the invention as defined by the appended claims.

As mentioned above, the invention can be used with quadrupole mass spectrometers, which measure the current of ions of a single mass during a measuring period of preset length while keeping the RF and DC voltages at the quadrupole mass filter substantially constant. A mass spectrum may be acquired by stepwise changing the RF voltage from one integer mass to the next; in other modes of operation, for instance in “single ion monitoring” (SIM) or “multiple reaction monitoring” (MRM), different species of ions of interest may not be measured in the sequence of their masses. Because the noise level for the measurement of an ion species cannot be safely predicted, the invention provides a method for the dynamic subtraction of actual noise levels during data acquisition by a statistical investigation of all measurements for a single ion mass, separately for all masses.

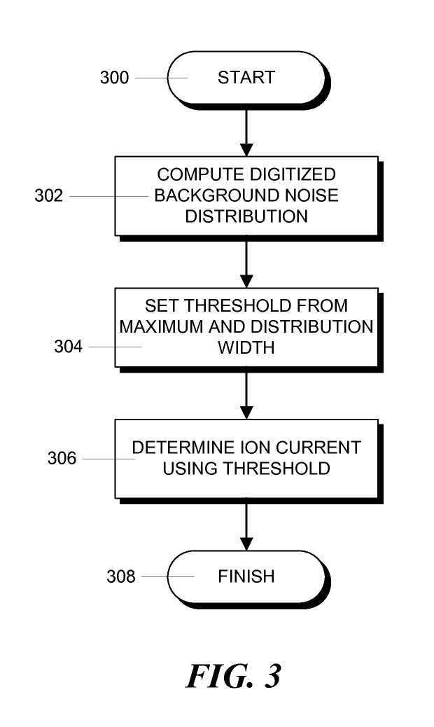

In more detail, and as shown in FIG. 3, the invention provides a dynamic method for the determination of ion currents in RF/DC quadrupole mass spectrometers which measure ion currents in time periods of substantially constant RF and DC voltages. This process begins in step 300 and proceeds to step 302, wherein, during data acquisition, the digitized background noise values of each time period are statistically investigated with respect to maximum and width of their distribution, wherein in step 304, the position of the maximum and the width are used to set a threshold to recognize true ion currents above noise for the corresponding time period. The noise level given by the position of the maximum of the distribution can be used to correct all measured ion current values above threshold as indicated in step 306. The process then finishes in step 308.

The ion current can be as well measured by counting the ions by their peaks above the threshold, if necessary, corrected statistically for overlapping peaks, or by determining the average ion current, wherein all measurement values of the ion current above the threshold are corrected by subtracting the noise level, then added to give an integrated ion current, and divided by the time length of the period.

It is most favorable to perform ion counting and to calculate the average ion current in parallel on the same set of measurement data, wherever possible. This permits the determination of the sensitivity of the multiplier for ions of a given mass by comparing the results from ion counting and ion current averaging. Knowledge of the multiplier's sensitivity in dependence of ion masses can be used to transform ion current measurements by ion counting into ion current measurements by averaging and vice versa. The knowledge even can be used to occasionally re-optimize the voltage for the multiplier.

If the noise of the measurement values from a measurement period cannot be evaluated statistically, the noise distribution maximum of a measurement of another nearby ion mass or from a time-wise nearby measurement period of the same ion mass can be used to correct the ion current measurements.

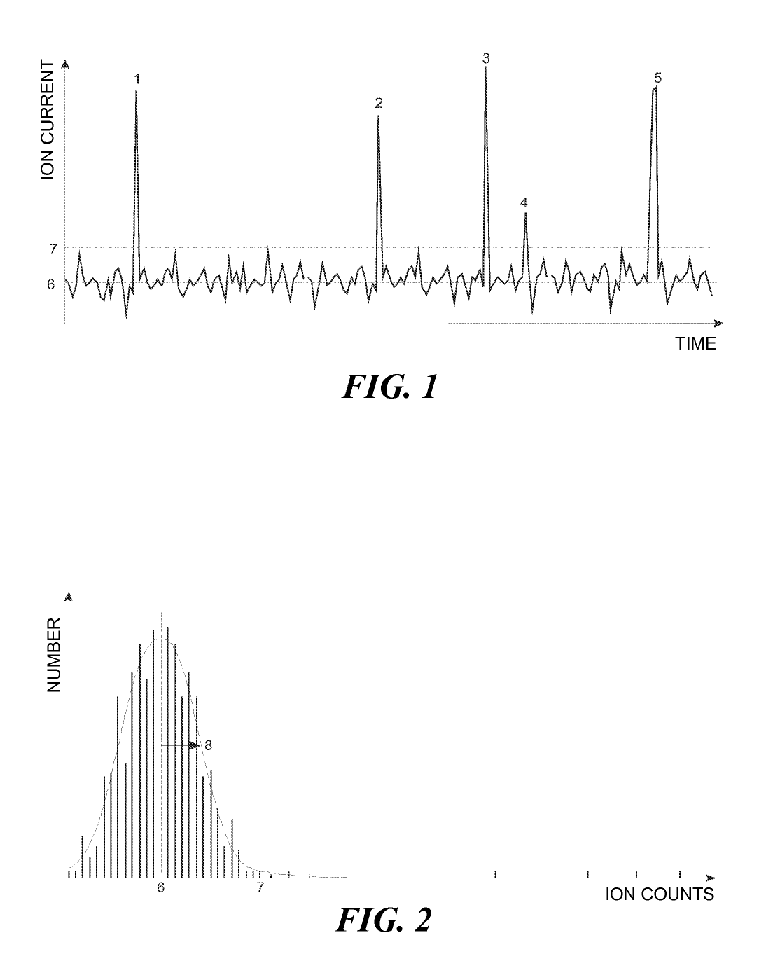

Ion detectors for quadrupole instruments can measure the ion current with measuring rates somewhere between 100 kilohertz and 1 megahertz with depths up to 18 bits. This is not extremely fast: time-of-flight mass spectrometers, for instance, use ion detector systems with measurement rates up to 5 gigahertz with digitization depths of 8 to 12 bits; but such ion detector systems are too expensive for rather inexpensive quadrupole instruments. As an example, a quadrupole GC-MS instrument may be operated with an ion detector of 160 kilohertz and 18 bits. For the acquisition of one MRM transition over a typical dwell time of 20 ms, 3200 sample measuring channels are measured and integrated. If the bandwidth of the amplifier is correctly adjusted to the analog-to-digital converter, the arrival of a single ion appears as a peak only covering one to two measuring channels. Therefore, the background noise is clearly visible, even if about 1000 ions should hit the detector in this time period, forming 1000 outstanding peaks above background noise. FIG. 1 presents a short section of such a measurement, showing the ion current detected by the detector versus time. The graph clearly illustrates 5 ion peaks (1-5) above detection threshold.

The statistical evaluation of the background noise may be performed in form of a histogram, as shown in FIG. 2. The histogram is divided in compartments for counting the measurement values each within a certain value range, ordered according to increasing values. For instance, the first compartment may count all digitized ion current values “0 counts of the ADC”, the second all ion current values “1”, the third all values “2”, and so on. With good approximation, the numbers in the histogram compartments form a Gaussian distribution with a maximum, say at “9.3 counts”, and a width parameter a between maximum and curve inversions at one of the sides, say “3.5 counts”. One count of the ADC may reflect a certain output voltage of the amplifier, say 40 microvolts. The position of the maximum of the Gaussian distribution in this histogram forms the average noise level iₐ=9.3 counts (372 microvolts) of the amplified ion current i, and the width parameter σ=3.5 counts of the Gaussian distribution represents the scattering width of the noise (with 40 microvolts per ADC count, an 18 bit ADC converts a maximum amplifier output of 10 volts into 256,000 ADC counts).

Ion current values above a detection threshold iₗᵢₘ=iₐ+b×σ have a certain minimum probability to be a true ion current peak, not a noise peak. For a given constant b, the minimum probability can be calculated from the known characteristics of Gaussian distributions. For b=2, a peak has the probability of p>97.75% to be a true ion peak; for b=3, the probability minimum amounts to 99.85%. On the other hand, the constant b can be chosen so that superseding peaks have a given minimum probability to be a true ion peak.

The true integrated ion current iᵢ=Σiₙ measured in the time interval Δt is given by the sum of all measurement values iₘ greater than threshold iₗᵢₘ, each measurement value iₘ corrected by subtraction of the average noise level iₐ: iₙ=iₘ−iₐ. The average ion current in the time interval is the integrated ion current iᵢ divided by the time interval Δt. This procedure can be performed as long as there is enough free background noise to be seen between ion peaks to determine the average noise level.

The calculations may be performed in the computer of the mass spectrometer, using tables for the histogram. The complete evaluation of the measurements of a single measurement period requires about three runs through the digitized data. The method is fast enough to be performed in the time of one period, for instance, in the next measuring period. In this way, the complete evaluation is ready at the end of a spectrum acquisition, or at the end of the GC run with MRM.

The ions impinging on the multiplier usually generate a few electrons only, forming the first avalanche generation. As a rule, only between 0 and 10 electrons are generated in the average, most often about 4-6 electrons. The number of electrons generated in a single impinging process follows a Poisson distribution; wherein the position of the maximum of the Poisson distribution can be altered by the voltage at the multiplier changing the amplification. Usually, the amplification of the multiplier and the electron current amplifier is chosen so high that the current of the electron avalanche supersedes the detection threshold iₗᵢₘ by a predetermined value, even if an ion produces only one electron on impingement on the first dynode. The amplification is critical: on one hand, no ions should get lost by not producing a single electron or by being lost in the background noise; on the other hand, the amplification should not be too high because the multiplier then tends to age rapidly, and high ion currents may supersede the upper limit of the ADC. There are methods for automatically adjusting the amplifications of multiplier and electron current amplifier, see, for instance, the document US 2009/0206247 A1 mentioned above.

Any ion current can be measured either by counting the ions per unit of time, or by measuring the average ion current, the latter usually by integrating the amplified ion current and dividing by the integration time. If the ion current is low enough and the amplification of the multiplier is chosen so high that the current of each electron avalanche clearly supersedes the detection threshold iₗᵢₘ, the number of ions can be counted instead of measuring the ion current, just counting the peaks above the limit iₗᵢₘ. If the number of ions measured within the time period is much smaller than the number of measurements, the number of peaks superseding the threshold iₗᵢₘ represents well the number of ions. For larger number of ions approaching the number of measurements, corrections can be used to consider the rate of overlapping peaks. If the number of ions is in the order of the number of measurements or is even larger, it may not longer be possible to count the ions; then, the average ion current has to be measured, using the correction for the noise level described above.

If the average has to be measured for high ion currents, the noise during the time period for the measurement of this mass cannot longer be seen and investigated. Maximum and width of the noise distribution has then to be taken from another nearby measuring period. If full scans over mass ranges are performed, a measurement of the noise for another nearby mass during the mass scan may be used for this correction, the other mass, if possible, not farther away than 10 atomic mass units. In GC runs with GC-MS instruments, the noise distribution for a measurement of the same mass, but from another nearby time period of the GC run may be used. The time period where the noise investigation is taken from, may not be further away than about 60 minutes.

The latter usually has to be applied to single ion monitoring (SIM) or multiple reaction monitoring (MRM) methods, the latter performed by triple quadrupole instruments. With MRM, the presence of target substances in GC runs can be detected with highest sensitivity. The first quadrupole mass filter isolates the molecular mass of the target substance which is then fragmented in the second quadrupole, and a key fragment ion is measured by the third quadrupole mass filter. Both the first and the third quadrupole are held on substantially constant RF and DC voltages for a longer measurement period, to achieve highest sensitivity. The method can switch the detection mode between different target substances or between different key fragment ions of the same target substance within the same GC run (therefore the term “multiple reaction monitoring”). When the noise cannot be determined because of high ion currents appearing during a substance peak eluting from the GC column, the maximum and width of the Gaussian noise value distribution has to be taken from nearby time periods with low or no ion currents, measuring ions of the same mass.

The relation between the average ion current measured in this way and the ion current measured by ion counting is given by the dependence of the multiplier's sensitivity on the ion mass. In the mass range in question, the sensitivity of the multiplier is roughly inversely proportional to the square root of the mass, but additionally depends on the structure of the ions. The relationship is not constant over time, it changes with multiplier age and use. If both data evaluation methods, ion counting and average ion current measurement, are synchronously applied wherever possible, the mass dependence of the multiplier sensitivity can be continuously and critically followed. The knowledge of this dependence at every given time can be used, on one hand, to transform values between number of ions (true ion current) and the average ion current measured by the multiplier, and, on the other hand, to occasionally correct the multiplier voltage to keep optimum performance of the multiplier. The multiplier voltage may be corrected after each GC run, or once every day, or even once every month, depending on the speed of sensitivity changes.

What is claimed is:

1. A method for the determination of an ion current in a quadrupole mass spectrometer which measures ion currents in time periods of substantially constant RF and DC voltages and produces an output signal, comprising:
(a) during data acquisition, statistically computing digitized background noise values of each time period including a maximum and a distribution width;
(b) using the position of the maximum and the distribution width to set a threshold used to recognize true ion currents above noise for a time period under investigation; and
(c) determining the ion current from true ion currents.

2. The method according to claim 1, further comprising correcting measured ion current values using a noise level given by the position of the maximum of the distribution.

3. The method according to claim 1, further comprising determining the ion current by counting ion peaks in the output signal above the threshold.

4. The method according to claim 3, further comprising statistically correcting a number of ions counted for overlapping peaks.

5. The method according to claim 2, further comprising determining the ion current as an average ion current by correcting all measurement values of the ion current above the threshold by subtracting the noise level, adding the corrected measurement values to give an integrated ion current, and dividing the integrated ion current by a length of the time period.

6. The method according to claim 1, wherein step (c) comprises:
(c1) counting ions peaks in the output signal above the threshold, and
(c2) simultaneously with step (c1) and using the same output signal, correcting all measurement values above the threshold by subtracting the noise level, adding the corrected measurement values to compute an integrated ion current, and dividing the integrated ion current by a length of the time period to compute an average ion current.

7. The method according to claim 6, wherein the quadrupole mass spectrometer includes a multiplier to measure ion currents and the method further comprises determining a multiplier sensitivity for ions of a given mass by comparing results from steps (c1) and (c2).

8. The method according to claim 7, wherein the multiplier sensitivity as function of mass is used to (i) transform ion current measurements obtained by ion counting into ion current measurements obtained by averaging and (ii) transform ion current measurements obtained by averaging into ion current measurements obtained by ion counting.

9. The method according to claim 7, wherein the multiplier sensitivity as function of mass is used to optimize the voltage for the multiplier.

10. The method according to claim 1, wherein when, in step (a), noise values of a measurement period cannot be statistically computed, using a noise distribution maximum of a measurement of another nearby ion mass to correct ion current measurements.

11. The method according to claim 1, wherein when, in step (a), noise values of a measurement period cannot be statistically computed, using a noise distribution maximum of another measurement period of an ion mass substantially the same as an ion mass in the measurement period, but nearby to correct the ion current measurements.
